(19) United States
(12) Patent Application Publication
(10) Pub. No.: US 2023/0274554 A1
(43) Pub. Date: Aug. 31, 2023

(54) SYSTEM AND METHOD FOR VEHICLE IMAGE CORRECTION

(71) Applicant: Continental Autonomous Mobility US, LLC, Auburn Hills, MI (US)

(72) Inventor: Ryan Stabel, Grand Blanc, MI (US)

(73) Assignee: Continental Autonomous Mobility US, LLC, Auburn Hills, MI (US)

(21) Appl. No.: 17/652,928

(22) Filed: Feb. 28, 2022

(51) Int. Cl. G06V 20/56; G06V 10/26; G06T 7/215; G06T 11/00; B60R 1/26

(52) U.S. Cl. CPC G06V 20/56; B60R 1/26; G06T 7/215; G06T 11/00; G06V 10/267; B60R 2300/30; B60R 2300/8066; G06T 2207/30252

(57) ABSTRACT

A method of processing a vehicle image includes obtaining a first image from at least one vehicle exterior camera when a vehicle is in a first position. An obstructed area is identified in the first image. At least one previously captured image is obtained from the at least one vehicle exterior camera when the vehicle is in a second position different from the first position. An unobstructed area of the at least one previously captured image that corresponds to at least a portion of the obstructed area of the first image is identified. The unobstructed area is stitched into at least a portion of the obstructed area to create a corrected image that corresponds to the first image with at least a portion of the obstructed area removed. The corrected image is displayed on a display in the vehicle.

### BACKGROUND

The present disclosure relates to a system and method for correcting vehicle images to remove obstructions.

Vehicles today generally include at least a rear-view camera and may even include a series of cameras that can provide a surround view of an exterior of the vehicle. Images from these cameras improve a driver’s field of view surrounding the vehicle. However, the cameras can become obstructed by weather conditions, such as snow or rain, or by dirt from simply driving the vehicle. The obstruction will need to be cleared from the camera in order to provide a clear view of the surroundings. However, this requires the driver to exit the vehicle and manually remove the debris or operate a vehicle integrated camera washer.

### SUMMARY

In one exemplary embodiment, a method of processing a vehicle image includes obtaining a first image from at least one vehicle exterior camera when a vehicle is in a first position. An obstructed area is identified in the first image. At least one previously captured image is obtained from the at least one vehicle exterior camera when the vehicle is in a second position different from the first position. An unobstructed area of the at least one previously captured image that corresponds to at least a portion of the obstructed area of the first image is identified. The unobstructed area is stitched into at least a portion of the obstructed area to create a corrected image that corresponds to the first image with at least a portion of the obstructed area removed. The corrected image is displayed on a display in the vehicle.

In another embodiment according to any of the previous embodiments, the obstructed area is identified by comparing the first image with the at least one previously captured image.

In another embodiment according to any of the previous embodiments, the first image is compared to the at least one previously captured image. Unchanged regions are identified between the first image and the at least one previously captured image.

In another embodiment according to any of the previous embodiments, the first image is compared to the at least one previously captured image by monitoring at least one vehicle dynamic.

In another embodiment according to any of the previous embodiments, the at least one vehicle dynamic is monitored by monitoring changes in the steering angle during a period of time between when the first image was obtained and the at least one previously captured image was obtained.

In another embodiment according to any of the previous embodiments, the at least one vehicle dynamic is monitored by monitoring changes in vehicle velocity during a time period between when the first image was obtained and the at least one previously captured image was obtained.

In another embodiment according to any of the previous embodiments, the at least one previously captured image includes a plurality of previously captured images.

In another embodiment according to any of the previous embodiments, the plurality of previously captured images are successive images.

In another embodiment according to any of the previous embodiments, unobstructed areas are identified in each of the plurality of previously captured images that correspond to the obstructed area in the first image.

In another embodiment according to any of the previous embodiments, the unobstructed area from the plurality of previously captured images are stitched into at least a portion of the obstructed area to create the corrected image.

In another embodiment according to any of the previous embodiments, the obstructed area is formed by an obstruction fixed relative to a lens of the at least one vehicle exterior camera.

In another embodiment according to any of the previous embodiments, the obstruction includes at least one of dirt or water.

In another embodiment according to any of the previous embodiments, the first image and the at least one previously captured image partially overlaps with the first image.

In another exemplary embodiment, a system for generating a rear-view image from a vehicle includes at least one vehicle exterior camera. A hardware processor is in communication with the at least one vehicle exterior camera. Hardware memory is in communication with the hardware processor. The hardware memory stores instructions that when executed on the hardware processor cause the hardware processor to perform operations. A first image from the at least one vehicle exterior camera is obtained when the vehicle is in a first position. An obstructed area in the first image is identified. At least one previously captured image is obtained from the at least one vehicle exterior camera when the vehicle is in a second position different from the first position. An unobstructed area of the at least one previously captured image that corresponds to the obstructed area of the first image is identified. The unobstructed area is stitched into at least a portion of the obstructed area to create a corrected that corresponds to the first image with at least a portion of the obstructed area removed.

In another embodiment according to any of the previous embodiments, the obstructed area is identified by comparing the first image with the at least one previously captured image.

In another embodiment according to any of the previous embodiments, the first image is compared to the at least one previously captured image by identifying unchanged regions between the first image and the at least one previously captured image.

In another embodiment according to any of the previous embodiments, the first image is compared to the at least one previously captured image by monitoring at least one vehicle dynamic.

In another embodiment according to any of the previous embodiments, the obstructed area is formed by an obstruction fixed relative to a lens of the at least one vehicle exterior camera.

In another embodiment according to any of the previous embodiments, the first image and the at least one previously captured image at least partially overlaps with the first image.

In another embodiment according to any of the previous embodiments, the at least one previously captured image includes a plurality of previously captured images. Identified unobstructed areas are included in each of the plurality of previously captured images that correspond to the obstructed area in the first image. The unobstructed area is stitched from the plurality of previously captured images into at least a portion of the obstructed area to create the corrected image.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example vehicle with having a camera image processing system.

FIG. 2A illustrates an image from the system of FIG. 1.

FIG. 2B illustrates a surround view set of images from the system of FIG. 1.

FIG. 3A illustrates a correction to the image of FIG. 2A.

FIG. 3B illustrates a correction to the set of images from FIG. 2B.

FIG. 4 illustrates a method of generating a corrected camera image for a vehicle.

### DESCRIPTION

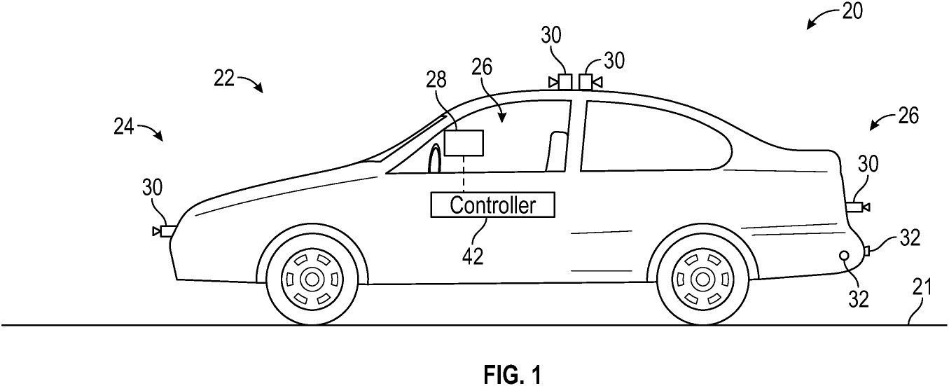

FIG. 1 illustrates an example vehicle 20 traveling on a roadway 21 having a rear-view image processing system 40. The vehicle includes a front portion 22, a rear portion 24, and a passenger cabin 26. The passenger cabin 26 encloses vehicle occupants, such as a driver and passengers, and includes a display 28 for providing information to the driver regarding the operation of the vehicle 20.

The vehicle 20 includes multiple sensors, such as cameras located on the front and rear portions 22 and 24 as well as a mid-portion of the vehicle 20. In addition to cameras 30, the vehicle 20 can include object detecting sensors 32, such as at least one of a radar sensor, an ultrasonic sensor, or a lidar sensor, on the front and rear portions 22 and 24.

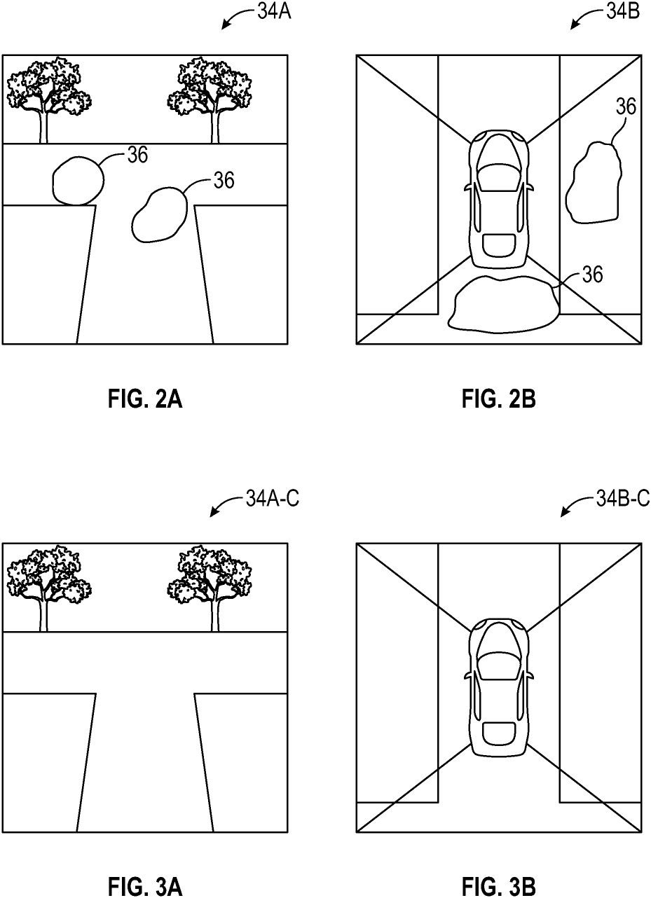

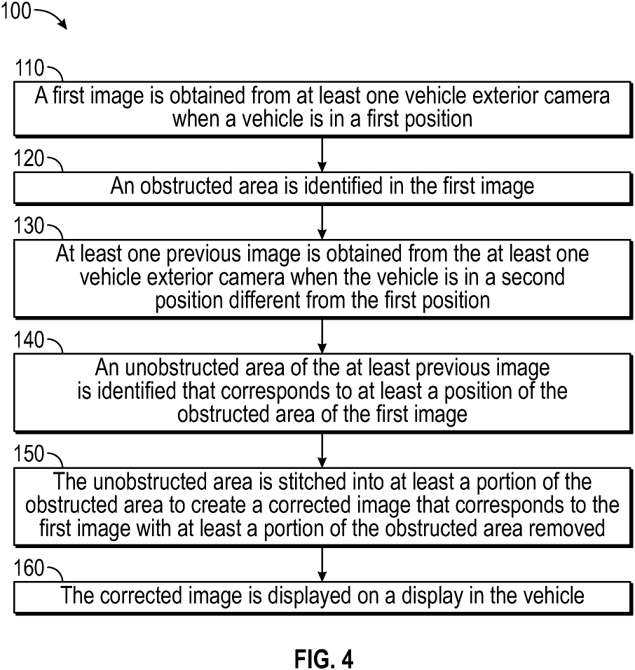

As shown in FIG. 2A a rear-view image 34A from the vehicle 20 includes multiple obstructed areas 36 that limit a field of view for the driver. Similarly, FIG. 2B illustrates an image 34B that create a surround view of the vehicle 20 that also include obstructed areas 36. One feature of this disclosure is to remove or decrease a size of the obstructed areas 36 shown in FIGS. 2A and 2B to produce corrected images 34A-C and 34B-C without the obstructed areas 36 as shown in FIGS. 3A and 3B, respectively.

The image processing system 40 includes a controller 42, having a hardware processor and hardware memory in communication with the hardware processor. The hardware memory stores instructions that when executed on the hardware processor cause the hardware processor to perform operations described in the method 100 of processing a vehicle image.

The method 100 includes obtaining a first image from one of the cameras 30 on the vehicle 20. (Block 110). The first image is obtained when the vehicle is located in a first position. Once the system 40 has obtained the first image, the system 40 identifies if there is an area obstructed area 36 in the first image. (Block 120). The obstructed area 36 identified by the system 40 includes objects that are fixed adjacent a lens of the rear-view camera 30, such as water or dirt, as opposed to a moveable object behind the vehicle 20, such as a trailer. Identifying the obstructed area in the first image includes identifying unchanged regions between the first image and previously captured images. The unchanged regions correspond to the obstructed area 36 because they do not change even when the vehicle 20 has changed position such that the cameras 30 would have a different field of view.

The system 40 then obtains at least one previously captured image from the same camera 30. (Block 130). Because the at least one previously captured image comes from the same camera 30, a perspective of the at least one previously captured image is similar as a perspective of the first image. In particular, the at least one previously captured image is obtained when the vehicle 20 is in a second position different from the first position when the first image was obtained and prior to obtaining the first image. However, the first image and the previously captured image at least partially overlap the same scene from the vehicle 20. This allows the system 40 to identify an unobstructed area in the previously captured image that corresponds to at least a portion of the obstructed area 36 in first image. (Block 140).

The system 40 can monitor vehicle dynamics to aid in finding the unobstructed areas from the previously captured image or successive previously captured images that correspond to the obstructed area 36 in the first image. The system 40 can monitor changes in vehicle velocity during a time period between when the first image was obtained and the earlier successive images were captured. The system 40 can also monitor changes in steering angle during a period of time between when the first image was obtained and each of the previous succession of images. The system 40 can use the information regarding velocity and steering angle to predict where in the previously captured images might correspond to the obstructed area 36 in the first image.

The system 40 can then stitch the unobstructed area from at least one of the previously captured images into the obstructed area in the first image to create a corrected image that corresponds to the first image with at least a portion of the obstructed area 36 removed. (Block 150). The system 40 can then display the corrected image on the display 28 within the passenger cabin 26. (Block 160).

If the obstructed area cannot be entirely removed from the first image or only removed up to a threshold level, such as 90% of the entire area of the first image, the system 40 can obtain additional previously captured images from the camera 30 stored on the memory. For example, the system 40 could obtain a third, fourth, fifth, or etc. previously captured image. The system 40 can then identify if the additional previously captured images includes an unobstructed area that corresponds to a portion of the remaining obstructed area 36 in the first image. The system 40 can then use the previously captured images to reduce a portion of the remaining obstructed area 36 in the first image until the portion that is obstructed in the corrected image is less than the predetermined threshold or until the previously captured images no longer include a view that corresponds to the obstructed area 36 in the first image.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of processing a vehicle image, the method comprising:
obtaining a first image from at least one vehicle exterior camera when a vehicle is in a first position;
identifying an obstructed area in the first image;
obtaining at least one previously captured image from the at least one vehicle exterior camera when the vehicle is in a second position different from the first position;
identifying an unobstructed area of the at least one previously captured image that corresponds to at least a portion of the obstructed area of the first image;
stitching the unobstructed area into at least a portion of the obstructed area to create a corrected image that corresponds to the first image with at least a portion of the obstructed area removed; and
displaying the corrected image on a display in the vehicle.

2. The method of claim 1, wherein identifying the obstructed area includes comparing the first image with the at least one previously captured image.

3. The method of claim 2, wherein comparing the first image to the at least one previously captured image includes identifying unchanged regions between the first image and the at least one previously captured image.

4. The method of claim 1, wherein comparing the first image to the at least one previously captured image includes monitoring at least one vehicle dynamic.

5. The method of claim 4, wherein monitoring the at least one vehicle dynamic includes monitoring changes in steering angle during a period of time between when the first image was obtained and the at least one previously captured image was obtained.

6. The method of claim 4, wherein monitoring the at least one vehicle dynamic includes monitoring changes in vehicle velocity during a time period between when the first image was obtained and the at least one previously captured image was obtained.

7. The method of claim 1, wherein the at least one previously captured image includes a plurality of previously captured images.

8. The method of claim 7, wherein the plurality of previously captured images are successive images.

9. The method of claim 7, including identifying unobstructed areas in each of the plurality of previously captured images that correspond to the obstructed area in the first image.

10. The method of claim 9, including stitching the unobstructed area from the plurality of previously captured images into at least a portion of the obstructed area to create the corrected image.

11. The method of claim 1, wherein the obstructed area is formed by an obstruction fixed relative to a lens of the at least one vehicle exterior camera.

12. The method of claim 1, wherein the obstruction includes at least one of dirt or water.

13. The method of claim 1, wherein the first image and the at least one previously captured image partially overlaps with the first image.

14. A system for generating a rear-view image from a vehicle, the system comprising:
at least one vehicle exterior camera;
a hardware processor in communication with the at least one vehicle exterior camera; and
hardware memory in communication with the hardware processor, the hardware memory storing instructions that when executed on the hardware processor cause the hardware processor to perform operations comprising:
obtaining a first image from the at least one vehicle exterior camera when the vehicle is in a first position;
identifying an obstructed area in the first image;
obtaining at least one previously captured image from the at least one vehicle exterior camera when the vehicle is in a second position different from the first position;
identifying an unobstructed area of the at least one previously captured image that corresponds to the obstructed area of the first image; and
stitching the unobstructed area into at least a portion of the obstructed area to create a corrected that corresponds to the first image with at least a portion of the obstructed area removed.

15. The system of claim 14, wherein identifying the obstructed area includes comparing the first image with the at least one previously captured image.

16. The system of claim 15, wherein comparing the first image to the at least one previously captured image includes identifying unchanged regions between the first image and the at least one previously captured image.

17. The system of claim 14, wherein comparing the first image to the at least one previously captured image includes monitoring at least one vehicle dynamic.

18. The system of claim 14, wherein the obstructed area is formed by an obstruction fixed relative to a lens of the at least one vehicle exterior camera.

19. The system of claim 14, wherein the first image and the at least one previously captured image at least partially overlaps with the first image.

20. The system of claim 14, wherein the at least one previously captured image includes a plurality of previously captured images;
wherein including identifying unobstructed areas in each of the plurality of previously captured images that correspond to the obstructed area in the first image; and
wherein including stitching the unobstructed area from the plurality of previously captured images into at least a portion of the obstructed area to create the corrected image.
